(19) United States
(12) Patent Application Publication
(10) Pub. No.: US 2010/0186682 A1
(43) Pub. Date: Jul. 29, 2010

(54) Durable, flexible pet toy with transparent cover

(75) Inventor: Phillip Ward Myers, JR., Wayzata, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Hyper Products, Inc., Wayzata, MN (US)

(21) Appl. No.: 12/321,918

(22) Filed: Jan. 27, 2009

(51) Int. Cl. A01K 29/00

(52) U.S. Cl. 119/709; 119/707

(57) ABSTRACT

A pet toy comprises an elastic core, a napped surface and an outer cover. The elastic core defines a shape of the pet toy. The napped surface covers the elastic core. The outer cover is durable, flexible and transparent, for protecting the elastic core from chewing activity while providing a view of the napped surface. The napped surface spaces the outer cover from the elastic core, such that the outer cover conforms to the shape of the pet toy.

### BACKGROUND OF THE INVENTION

This disclosure relates generally to pet products, and specifically to pet toys. In particular, the disclosure concerns a durable chew toy for dogs, cats and other domestic animals.

Across the world, pets are a mainstay of domestic life. In the United States alone, some seventy million households have at least one pet, and some sixty million of these include a dog or cat. Each of these pets has a number of basic needs, including food, water and shelter. Pets also benefit from regular exercise and the opportunity for healthy play activities.

Dogs and other small mammals have a particular need for play activity that involves chewing. Designed correctly, chew toys are amusing for both owner and pet, improve oral hygiene, and reduce undesirable behaviors directed at furniture, clothing, fixtures and the like. Well-designed chew toys can also be incorporated into retrieval training, exercise regimens and other indoor or outdoor activities.

Chew toys are made from a variety of materials, including wood, rubber, hard plastics, leather and animal or cereal meal, each of which experiences a variety of known limitations. Some materials are simply not attractive to particular pets, and toys made from these materials are not well used. Other materials are prone to cracking and splitting, creating sharp edges that can cause injury to the pet or owner. Some materials have an affinity for surface moisture, resulting in strong odors and unsanitary, unaesthetic conditions, while other materials are not sufficiently durable, producing small pieces that scatter around the pet's environment, including hard-to-clean areas such as carpets, furniture and lawns, or are unintentionally ingested.

These problems can are of particular concern for vigorous chewers, both large and small, with a propensity to eat away at traditional chew toys in short order, even those specifically designed for long-term use. As a result, there is a need for durable pet toys that are resistant to splitting, cracking, flaking, peeling and other damage, even when subject to vigorous activity, that are attractive to both pet and owner, and are adaptable to a wide range of play and exercise activities.

### BRIEF SUMMARY OF THE INVENTION

This disclosure concerns a durable, flexible pet toy with a transparent cover. The pet toy comprises an elastic core, a textile surface and an outer cover. The elastic core defines a shape for the pet toy. The textile surface is napped, and covers the core. The textile surface also spaces the outer cover from the elastic core, such that the outer cover conforms to the toy's shape. The outer cover is durable, flexible and transparent, in order to provide a view of the textile surface while protecting the elastic core and textile surface from chewing activity.

### BRIEF DESCRIPTION OF THE DRAWINGS

FIG. 1A is a schematic view of a durable, flexible pet toy with transparent cover, in a ball-shaped embodiment.

FIG. 1B is a cross-sectional view of the pet toy as embodied in FIG. 1A.

FIG. 2A is a schematic view of a durable, flexible pet toy with transparent cover, in a bone-shaped embodiment.

FIG. 2B is a cross-sectional view of the pet toy as embodied in FIG. 2A.

FIG. 3 is a schematic view of a durable, flexible pet toy with transparent cover, in a block-shaped embodiment.

FIG. 4 is a schematic view of a durable, flexible pet toy with transparent cover, in a stick-shaped embodiment.

FIG. 5A is a schematic view of a durable, flexible pet toy with transparent cover, in a doughnut-shaped embodiment.

FIG. 5B is a cross-sectional view of the pet toy as embodied in FIG. 5A.

### DETAILED DESCRIPTION

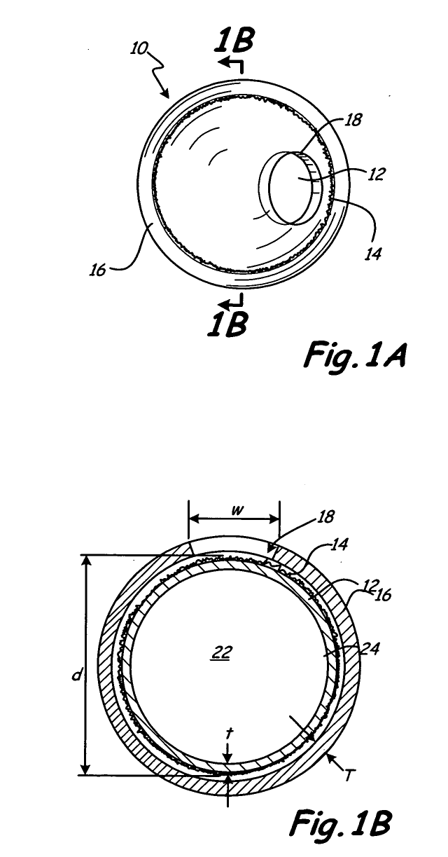

FIG. 1A is a schematic view of durable, flexible pet toy 10, in a ball-shaped embodiment. Pet toy (or toy) 10 comprises elastic core 12, napped textile surface 14 and transparent outer cover 16. In this particular embodiment, toy 10 is a chew toy in which plastic core 12 with napped surface 14 defines a spherical or ball shape. In other embodiments, toy 10 is bone-shaped, block-shaped, stick-shaped, doughnut-shaped or has another form, as described below.

Elastic core 12 is comprised of a material with plastic and elastic properties, such that the material changes shape in response to chewing activity and other pressure-related forces, stresses and strains, and such that the material returns to its original shape when the forces, stresses and strains are removed. The material of elastic core 12 is also semi-pliable or semi-compliant, such that elastic core 12 is malleable and at least partially yields in response to moderate chewing activity, but substantially retains its shape even when subject to vigorous chewing activity, including vigorous chewing activity from large domestic pets.

Suitable materials for elastic core 12 include natural and synthetic rubbers such as polybutadiene, thermoplastic or thermoset elastomer/rubber (TPE or TPR) materials including thermoplastic polystyrene and polyurethane, and other relatively high density elastic polymers. Unsuitable materials include inelastic and non-malleable materials such as hard plastics, metals, and other rigid polymers, which do not deform in response to relatively moderate chewing activity and other external forces, stresses or strains. Additional unsuitable materials include fully compliant materials such as polyurethane foam and other foamed polymers, which do not at least partially retain their original shape when subject to high external forces, stresses and strains, and materials that do not return to their original shape after deformation.

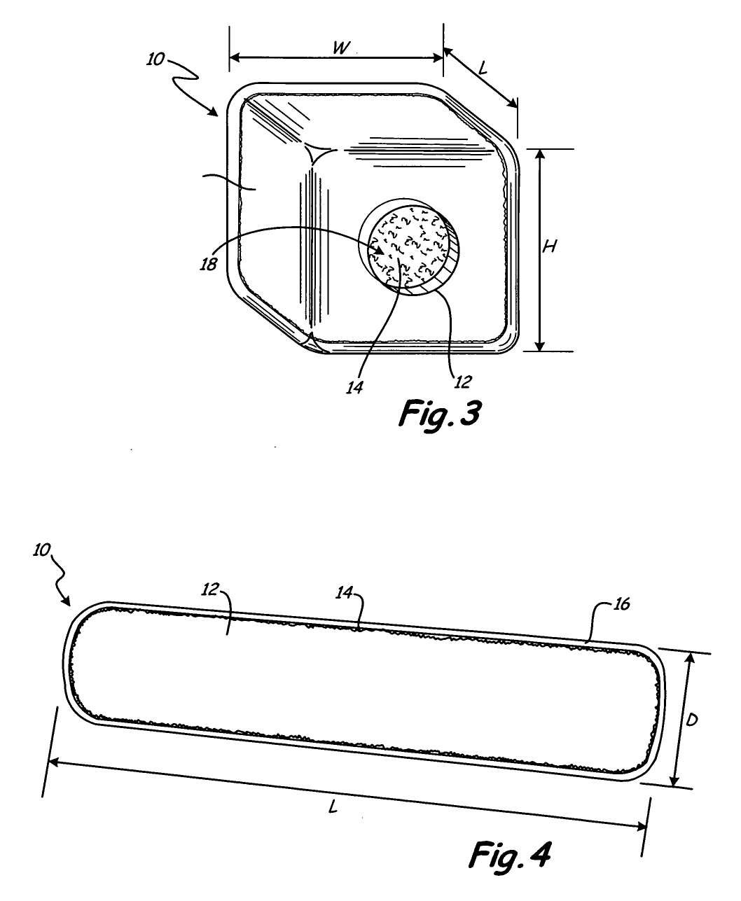

Napped surface 14 comprises a textile material with a nap or pile defined by the orientation of individual textile fibers. For purposes of clarity, FIGS. 1A and 1B show the nap or pile along the cross-sectional perimeter of surface 14, but the nap or pile is understood to extend over any or all of surface 14 (see, e.g. FIG. 3, below).

In some embodiments, napped surface (or textile surface) 14 is formed of an animal-based natural fiber material such as wool, fur or hair, a plant-based natural fiber material such as cotton, or an artificial cellulosic fiber material such as rayon. In other embodiments, napped surface 14 is comprised of a synthetic fiber material such as nylon, or a combination of natural, artificial and synthetic fiber materials. Typically, the fibers of napped surface 14 are formed into an unwoven textile or felt, but in some embodiments the fibers are woven into a cloth or cloth-like textile material having an unwoven pile or nap component.

Napped surface 14 is provided in a range of colors and tones. Typical colors include optic yellows and optic greens (such as are commonly used for tennis balls), other shades of yellow and green, reds, oranges, blues, purples, various shades of white and black, and combinations thereof. The different colors of napped surface 14 are sometimes mixed together, and sometimes provided in geometrical patterns. In some embodiments, napped surface 14 is provided in colors, tones and patterns that stimulate or are attractive to the visual senses of particular animals, such as dogs, cats, or other pets and domestic animals. In other embodiments, napped surface 14 is provided in colors, tones and patterns that stimulate or are attractive to the visual senses of people, or the visual senses of both people and the particular pets or animals with whom they interact.

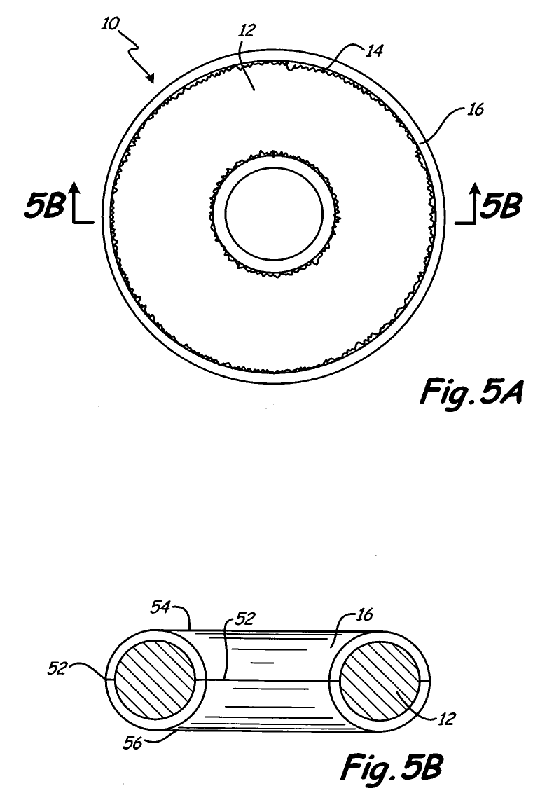

Outer cover 16 comprises a durable, flexible material that is sufficiently resilient to conform to the form of elastic core 12 when it is deformed, and also tough and strong enough to resist punctures and cuts during vigorous chewing and play or exercise activity. Outer cover 16 also includes means for inserting elastic core 12 covered with napped surface 14, such as flexible aperture 18 or, alternatively, a seam as described with respect to FIGS. 5A and 5B, below.

Suitable materials for outer cover 16 include the TPE and TPR materials discussed above, with the limitation that outer cover 16 is further transparent, in order to provide an interior view of napped surface 14 on elastic core 12. As used herein, the term transparent encompasses transparent, translucent and semi-transparent materials, which allow light to pass through either partially or wholly, so that all or part of napped surface 14 on elastic core 12 is visible through the material of outer cover 16.

In some embodiments, outer cover 16 is formed of a clear transparent material that is substantially untinted, providing a distinct view of napped surface 14 covering elastic core 12. In other embodiments, the material of outer cover 16 includes a tint, such as a red, yellow, green or blue tint, or a combination thereof, or is otherwise semitransparent or translucent. Typically, tints used for cover 16 coordinate with the color of napped surface 14, but in some embodiments a tint is used to change or enhance the color of napped surface 14, such as to make a white surface appear colored, to make a colored surface appear neutral, or to change the color or shade of napped surface 14.

FIG. 1B is a cross-sectional view of pet toy 10, taken along line 1B-1B through the embodiment of FIG. 1A. The cross-sectional view shows the structure and relative dimensions of elastic core 12, napped surface 14 and outer cover 16 with flexible aperture 18.

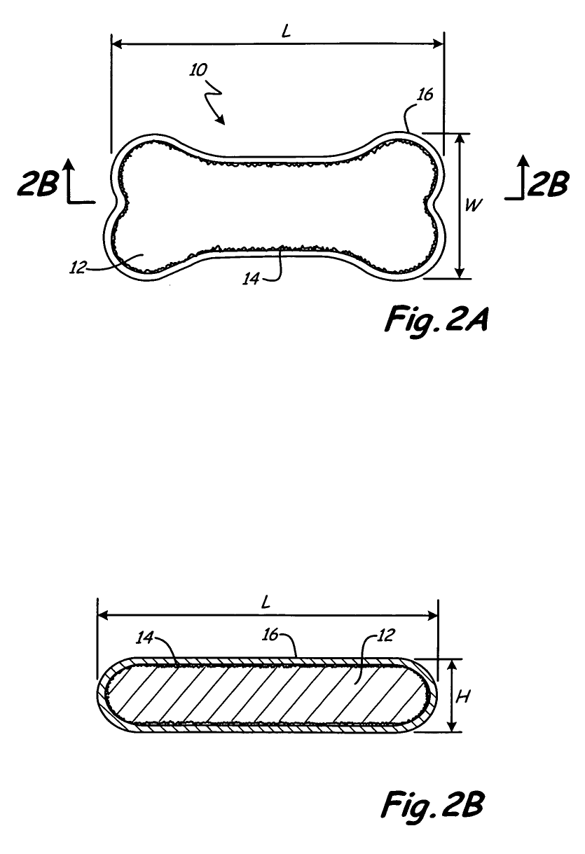

Elastic core 12 with napped surface 14 defines the shape of toy 10. In some embodiments, elastic core 12 comprises internal cavity 22, in order to reduce material usage or weight, or to increase the deformability of elastic core 12 and toy 10. In other embodiments, elastic core 12 is substantially continuous, as shown, for example, in FIG. 2B. In further embodiments, internal cavity 22 is filled with a different material from elastic core 12, or a number of different materials, in order to change the elastic and plastic properties of elastic core 12, to increase or reduce overall weight, to provide an asymmetric center of balance, or to perform a related function.

Napped surface 14 covers at least part of elastic core 12, and typically all of elastic core 12. Outer cover 16 conforms to the shape of elastic core 12 about napped surface 14, such that napped surface 14 spaces outer cover 16 from elastic core 12. In some embodiments, elastic core 12 is adjacent to outer cover 16 along napped surface 14, as shown in FIG. 1A. In other embodiments, gap 24 forms as air gap or other space between elastic core 12 and outer cover 16, along at least part of napped surface 14. In some of these embodiments, unwoven fibers of napped surface 14 extend into gap 24, such that napped surface 14 and gap 24 co-extend or overlap along all or part of outer cover 16.

In the manufacture of toy 10, elastic core 12 is molded, cut, extruded or otherwise formed to define the core shape of toy 10. Napped surface 14 is attached, applied or formed onto elastic core 12, or co-formed with elastic core 12.

Outer cover (or outer surface) 16 is molded, cut, extruded or otherwise formed to conform to the shape of elastic core 12. Outer core 16 includes means for inserting elastic core 12 with napped surface 14, such that outer cover 16 covers elastic core 12 about napped surface 14.

In the particular embodiment of FIGS. 1A and 1B, for example, outer cover 16 has flexible aperture 18, which is sufficiently flexible to accommodate elastic core 12 with napped surface 14 by stretching. Typically, insertion is performed while the material of outer cover 16 is still warm from a manufacturing process, or after heating to improve stretching characteristics. In these embodiments, the elastic properties of outer cover 16 typically decrease at normal ambient temperatures, so that it is difficult or impossible to remove elastic core 12 during normal use.

Durable, flexible, transparent outer cover 16 is resistant to cuts, tears, punctures and other play-related or exercise-related damage, even when subject to vigorous chewing activity from large and enthusiastic animals. Outer cover 16 also provides a relatively soft chewing surface that is attractive to pets, while protecting elastic core 12 and napped surface 14 from damage, including damage due to worrying, gnawing, clawing, and other chewing-related behaviors. This provides toy 10 with substantial service life, while enhancing appearance and reducing the possibility of a pet or other animal ingesting small pieces or scattering hard-to-clean debris on floors, carpet, furniture, lawns and other surfaces.

In the particular embodiment of FIGS. 1A and 1B, toy 10 is a tennis-ball shaped object. In this embodiment, internal cavity 22 forms an internal void or air space, which is sometimes pressurized during manufacture at up to two atmospheres or more. When covered with napped surface 14, elastic core 12 has diameter d of about two and one half inch (about 64 mm), preferably between about two and a half and about two and five eighths inch (that is, d≧64 mm and d≦67 mm).

In some of these embodiments, thickness t of elastic core 12 is relatively small (t≦about 3.0 mm), and elastic core 12 with napped surface 14 has a total weight of about two ounces (2 oz), or between about two ounces and about two and one sixteenth ounce (corresponding to non-buoyant mass m between about 56.7 g and about 58.5 g). Alternatively, thickness t of elastic core 12 is relatively greater, in excess of one half inch (t≧about 12.7 mm), and the weight and mass vary accordingly. In further embodiments, both diameter d and thickness t vary, with diameter d ranging up to 15 cm (150 mm) or more. Thickness t ranges up to one half of diameter d, such that cavity 22 is relatively small, or absent.

Thickness T of outer cover 16 also varies, typically scaling with the dimensions of elastic core 12. For smaller toys, thickness T ranges from a minimum of about 3 mm or more, up to a maximum of about 1 cm for larger toys (that is, 3 mm≦T≦10 mm). Alternatively, thickness T of outer cover 16 ranges from a minimum of about 1 mm for quite small toys to a maximum of about 2-3 cm for very large toys (that is, T≧1 mm or T≦3 cm, respectively).

The dimensions of flexible aperture 18 also vary. In tennis-ball based embodiments, flexible aperture 18 is approximately round and dime-sized, with relaxed width w of approximately 18 mm or less. In this embodiment, aperture 18 is sufficiently flexible to accommodate inner core with diameter d of about 64 mm or more, including napped surface 14. This provides a width ratio (d/w) of at least three to one with respect to elastic core 12 (that is, about 3.5:1, or between 3:1 and 4:1), and an area ratio (d²/w²) of at least ten to one (that is, about 12.4:1, or between 10:1 and 15:1). For larger or smaller elastic cores, including baseball-shaped, football-shaped and more general core geometries, width w of aperture 18 generally scales based on these minimum ratios.

FIGS. 2A and 2B are schematic views of durable, flexible pet toy 10 in a bone-shaped embodiment, with the cross-sectional view of FIG. 2B taken along line 2B-2B in FIG. 2A. In this embodiment, toy 10 comprises elastic core 12, napped surface 14 and transparent outer cover 16, as described above, with elastic core 12 defining the shape of a bone or other skeletal member for toy 10.

Bone-shaped embodiments of toy 10 typically have an overall length L of about four inches to about twelve inches, including outer cover 16 (that is, 10 cm≦L≦30 cm). In these embodiments, overall width W of toy 10 typically ranges from about one inch to about three inches (that is, 2.5 cm≦W≦8 cm), and overall height H of toy 10 typically ranges from about one inch to about two inches (2.5 cm≦H≦5 cm).

As shown in FIG. 2B, elastic core 12 of toy 10 is substantially continuous, without internal cavity 22 as shown in FIG. 1B. This typically increases the overall weight and density of toy 10, and decreases maximum deformation. Alternatively, an internal cavity is provided. In these embodiments, the internal cavity is either formed as a void or air space, or filled with another material (that is, a material different from the material of elastic core 12), in order to change the weight or elastic properties of toy 10 as described above.

FIG. 3 is a schematic view of durable, flexible pet toy 10 with elastic core 12, napped surface 14 and transparent outer cover 16, as described above, in a block-shaped embodiment. In this embodiment, elastic core 12 with napped surface 14 defines a right rectangular prism, a triangular prism, a skew rectangular prism, or similar rectangular, triangular or other block-based shape for toy 10.

In the generally square block embodiment of FIG. 3, overall length L, width W and height H are approximately the same (L≈W and W≈H), with each typically being about six to eight inches (15 cm≦L, H, W≦20 cm) or less, including outer cover 16. In other embodiments, overall length L, width W and height H each vary, with overall length L typically defined as the greatest dimension and overall height typically H defined as the least dimension (that is, L≧W and W≧H). In these embodiments, overall length L typically ranges from about four inches to about twenty-four inches (that is, 10 cm≦L≦61 cm), overall width W typically ranges from about one inch to about three inches (2.5 cm≦W≦6.4 cm), and overall height H typically ranges from about one inch to about three inches (2.5 cm≦H≦7.6 cm)

FIG. 4 is a schematic view of durable, flexible pet toy 10 with elastic core 12, napped surface 14 and transparent outer cover 16, as described above, in a stick-shaped embodiment. In this embodiment, elastic core 12 with napped surface 14 defines a generally elongated cylinder or other stick-based shape for toy 10.

In stick-shaped embodiments, overall length L of toy 10 typically varies from about four inches to about twenty-four inches, including outer cover 16 (10 cm≦L≦60 cm), and overall width W ranges from about one inch to about three inches (2.5 cm≦W≦6.4 cm). In substantially cylindrical or baton-shaped embodiments, overall width W corresponds roughly to the overall diameter of toy 10. In more general embodiments having oval or irregular cross-sections, overall length L is defined as the greatest axial dimension, overall width W is defined as the greatest cross-sectional dimension, and overall height H is defined as the greatest dimension perpendicular to overall length L and overall height W, with W≦L and H≦W.

FIGS. 5A and 5B are schematic views of durable, flexible pet toy 10 in a doughnut-shaped embodiment, with FIG. 5B taken along line 5B-5B in FIG. 5A. In this embodiment, toy 10 comprises elastic core 12, napped surface 14 and transparent outer cover 16, as described above, with elastic core 12 defining a toroidal or doughnut-based shape for toy 10.

In the manufacture of toy 10 with seam or seams 52, outer cover 16 is molded, cut, extruded or otherwise formed in at least two pieces, such as top piece 54 and bottom piece 56, which are divided or separated along seam(s) 52. As shown in FIG. 5B, elastic core 12 with napped surface 14 is inserted into at least one of separate parts 54 and 56, and parts 54 and 56 are joined along seams 52 to form pouter cover 16 of toy 10. Outer cover 16 conforms to the shape of elastic core 12 about napped surface 14, with napped surface 14 spacing outer cover 16 from elastic core 12 as described above.

In some embodiments, such as the toroidal embodiment of FIGS. 5A and 5B, the geometry and topology of toy 10 prevent elastic core 12 from being inserted through a flexible aperture, making alternate means such as seams 52 necessary for the insertion step. Alternatively, seams 52 are use in place of a flexible aperture regardless of geometry, in order to prevent the absorption of saliva, water and other sources of moisture, reduce the susceptibility of toy 10 to unpleasant odors and unsanitary conditions, maintain attractiveness and aesthetic value, and increase service life.

In typical embodiments, the materials and construction of elastic core 12, napped surface 14 and outer cover 16 provide relatively low density, such that toy 10 floats on water, and in particular floats on fresh water. This improves compatibility with a range of outdoor and exercise activities, including fetch and water retrieval. In alternative embodiments, the materials and construction techniques of toy 10 are selected such that toy 10 sinks.

In addition, outer cover 16 is typically washable in order to keep toy 10 clean and attractive. Note, however, that toy 10 benefits from washability and reduced moisture absorption even in sinking embodiments, and in embodiments having a flexible aperture instead of seam(s) 52, or when outer cover 16 is cut, pierced, or otherwise damaged.

The present invention has been described with reference to preferred embodiments, but the terminology used is for the purposes of description, not limitation. Workers skilled in the art will recognize that changes may be made in form and detail without departing from the spirit and scope of the invention.

1. A pet toy comprising:
an elastic core for defining a shape of the pet toy;
a napped surface for covering the elastic core; and
a durable, flexible, transparent outer cover for protecting the elastic core from chewing activity while providing a view of the napped surface;
wherein the napped surface spaces the outer cover from the elastic core, such that the outer cover conforms to the shape of the pet toy.

2. The pet toy of claim 1, wherein the elastic core is formed of a thermoplastic elastomer material.

3. The pet toy of claim 1, wherein the napped surface is formed of a felt material.

4. The pet toy of claim 1, wherein the shape of the pet toy comprises a ball shape.

5. The pet toy of claim 4, wherein the ball shape comprises a tennis ball shape and the napped surface has one of an optic yellow or optic green color.

6. The pet toy of claim 1, wherein the shape of the pet toy comprises at least one of a bone shape, a stick shape, a block shape and a doughnut shape.

7. The pet toy of claim 1, wherein the outer cover is formed of a transparent thermoplastic rubber material having a thickness between about 1 mm and about 5 mm.

8. The pet toy of claim 7, wherein the thermoplastic rubber material is tinted.

9. The pet toy of claim 1, wherein the pet toy floats in fresh water.

10. The pet toy of claim 1, further comprising a flexible aperture for inserting the elastic core into the outer cover by means of stretching the flexible aperture while the outer cover is heated.

11. A chew toy comprising:
a core shape comprising:
an elastic material forming the core shape; and
a textile surface covering the elastic material; and
an outer cover comprising:
a flexible, transparent, chew-resistant cover material conforming to the core shape about the textile surface; and
means for inserting the core shape into the outer cover.

12. The chew toy of claim 11, wherein the textile surface is napped.

13. The chew toy of claim 11, wherein the core shape has a substantially continuous interior.

14. The chew toy of claim 11, wherein the core shape comprises a sphere.

15. The chew toy of claim 14, wherein the sphere has a diameter of about two and one half inches (about 64 mm).

16. The chew toy of claim 11, wherein the core shape comprises at least one of a cylinder, a torroid, a rectangular block and a skeletal member.

17. The chew toy of claim 16, wherein the chew toy has an overall length of about twenty-four inches (about 61 cm) or less, and an overall width of about three inches (8 cm) or less.

18. The chew toy of claim 11, wherein the outer cover comprises thermoplastic rubber having a thickness between about 1 mm and about 10 mm, inclusive.

19. The chew toy of claim 18, wherein the means for inserting the core shape comprise an aperture that stretches to admit the core shape, and wherein the aperture has a relaxed width no greater than one third of a greatest cross-sectional dimension of the core shape.

20. The chew toy of claim 18, wherein the means for inserting the core shape into the outer cover comprise a seam for joining at least two portions of the outer cover about the core shape and the textile surface.

21. A toy comprising:
a substantially continuous, elastic core material defining a shape of the toy;
a felt material covering the core material; and
a soft, durable, transparent thermoplastic material surrounding the napped felt material, such that the thermoplastic material conforms to the shape of the toy and protects the toy from vigorous chewing activity, while providing a view of the napped felt material.

22. The toy of claim 21, wherein the shape of the toy comprises at least one of a ball, a bone, a stick, a block and a doughnut shape.

23. The toy of claim 21, wherein the thermoplastic material comprises a thermoplastic rubber material having a flexible aperture for inserting the core material and the felt material covering the core material.

24. The toy of claim 21, wherein the toy floats on fresh water.
